(19) United States
(12) Patent Application Publication
(10) Pub. No.: US 2026/0002096 A1
(43) Pub. Date: Jan. 1, 2026

(54) BIOFILM-DEGRADING COMPOSITION

(71) Applicant: REALCO, Louvain-la-Neuve (BE)

(72) Inventors: Laurent DELHALLE, Esneux (BE); Martine WEICKMANS, Héron (BE); Sébastien FASTREZ, Nouvelles (BE)

(21) Appl. No.: 19/112,862

(22) PCT Filed: Sep. 25, 2023
(86) PCT No.: PCT/EP2023/076367

§ 371 Date: Mar. 18, 2025

(30) Foreign Application Priority Data
Sep. 23, 2022 (BE) BE2022/5765

(51) Int. Cl. C11D 3/386; A01N 63/50; A01P 1/00; C11D 3/36; C11D 3/43; C11D 3/48

(52) U.S. Cl. CPC C11D 3/38636; A01N 63/50; A01P 1/00; C11D 3/361; C11D 3/38618; C11D 3/43; C11D 3/48

(57) ABSTRACT

Biofilm-degrading composition comprising a DNAse, uses thereof and method of degrading biofilms comprising the application of this composition.

### TECHNICAL FIELD

This invention relates to a biofilm-degrading composition comprising a specific DNAse.

### PRIOR ART

In many fields of activity such as the agri-food sectors, communities, medical and veterinary sectors, cosmetic industries, the pharmaceutical, “life science” or biotechnology sectors, problematic contamination due to the presence of microorganisms is encountered very frequently.

These biofilms can be treated in different ways, but it is still difficult to ensure that the treatment to be applied will be effective. In particular, biocide or antibiotic molecules, which are known to destroy bacteria in planktonic form, are frequently ineffective against these same bacteria in the form of biofilm.

In addition, in practice, and unlike in the laboratory, the composition of a biofilm contaminating a surface is very generally unknown.

Finally, applications in the agri-food or medical fields, or even for GMP (Good Manufacturing Practice) production involve limitations in terms of the compounds that can be used, which makes the treatment of biofilms more difficult. For example, pipes are difficult to disinfect due to restricted access. Similarly, medical instruments, such as endoscopes, are difficult to disinfect, due to (i) their surface, which can be very uneven, and (ii) the impossibility of applying many usual physical or chemical treatments, such as heat treatments, products that would damage them or be incompatible with subsequent use on a patient.

Different types of enzymes have been tested and used successfully to degrade biofilms. However, some biofilms are not adequately deconstructed with a single enzyme activity, while mixtures of enzymes, particularly when there are proteases, do not necessarily allow for liquid compositions that are stable over time. In addition, as will be described below, for a biofilm of given composition, the inventors have noted that current enzyme compositions frequently exhibit significant variations in terms of effectiveness, which complicates the work required to achieve an optimal formulation.

Patent application WO2022079318 describes the use of a particular nuclease (Denarase), with increased effectiveness.

U.S. Pat. No. 10,954,497 describes a category of HNH DNAses having a GYS motif and the effectiveness thereof when formulated for the destruction of biofilms.

### BRIEF SUMMARY OF THE INVENTION

This invention relates to a liquid composition for preventing or removing a biofilm, comprising one or more surfactant(s), one or more sequestering agent(s) and a phosphodiesterase having a deoxyribonuclease (DNAse) activity, said DNAse being one or more HNH-type DNAse(s) and/or having at least 95% identity with one of the sequences SEQ ID NO: 1 to SEQ ID NO: 13 (or SEQ ID NO: 13). 1 to SEQ ID NO: 18).

This invention also relates to the use of this composition for removing a biofilm comprising a lactic acid bacterium selected from Lacobacillus sp, Pediococcus sp, Lactococcus sp. Streptococcus sp, Teragenococcus sp, Leuconostoc sp, Oenococcus sp, Bifidobacterium sp, and/or Listeria monocytogenes, Stenotrophomonas maltophilia, Bacillus cereus, Bacillus subtilis,
and/or Listeria monocytogenes, Stenotrophomonas maltophilia, Bacillus cereus, Bacillus subtilis,
and/or Pseudomonas fluorescens, Pseudomonas aeruginosa, Staphylococcus aureus, Escherichia coli, Klebsiella pneumoniae, Enterobacter cloacae, Citrobacter freundii, Staphylococcus epidermidis or Clostridium sp.

This invention also relates to a method for removing a biofilm on a surface comprising the application to said surface of this liquid composition.

This invention also relates to a liquid (boost) composition comprising β-1,6-N-acetylhexosaminidase (Dispersin B) and a phosphodiesterase having deoxyribonuclease (DNAse) activity, said DNAse being one or more HNH-type DNAse(s) and/or having at least 95% identity with one of the sequences SEQ ID NO: 1 to SEQ ID NO: 13 13 (or SEQ ID NO: 1 to SEQ ID NO: 18).

### DETAILED DESCRIPTION OF AN EMBODIMENT OF THE INVENTION

The inventors sought to improve compositions against biofilms, in particular to obtain compositions whose spectrum of activity is sufficiently broad and consistent, and which ensures a considerable reduction in the number of microorganisms protected by the biofilm.

To do this, the inventors identified a DNAse that is particularly effective against certain types of biofilms.

Furthermore, depending on the biofilms, this DNAse is very effective, either alone or in synergy with other enzyme activities.

Furthermore, the inventors succeeded in formulating this DNAse in such a way that it retains its activity, even over time (even in the presence of a protease in the composition or sequestering agents), which first of all allows for reasonable commercial logistics between the time when the liquid (aqueous) composition is formulated and the time when it will be used.

The composition according to the invention is preferably used on surfaces. In the context of this invention, the terminology “surface” is preferably understood in a broad sense, therefore it includes the internal surface of a pipe, or even surfaces of reusable medical devices, in particular endoscopes and surgical instruments.

Indeed, the inventors have tested the effect of this DNAse alone, compared to other nucleases known for their remarkable activity, such as Denarase (as in WO2022079318), and the effect of this DNAse in synergy with other enzymes, either in a mixture or in sequential application, and have noted an increased or more constant effectiveness, depending on the type of biofilm to be treated. Indeed, to their surprise, the inventors compared, under well-controlled laboratory conditions, the effect on biofilms of the compositions (protease+amylase+lipase+detergent+mild sequestrant) without this DNAse and of the same compositions with the DNAse of the invention and, in the case of the compositions without this DNAse, they sometimes noted good results and sometimes mediocre results, while the compositions enriched with the DNAse of this invention always showed very good results. Therefore, it took many tests, which were repeated many times, to clearly identify the effect of the DNAse of this invention, and the results shown below are among the most remarkable.

### Sequence Listing

Sequences 1 to 11, as well as 14 to 18, represent DNAses according to the invention. These are HNH-type DNAses.

Sequence 12 is the consensus sequence in its broadest sense.

Sequence 13 is a consensus sequence incorporating preferred amino acids at key positions, especially in the central part of the enzyme.

With regard to sequences 12 and 13, the amino acids that may be subject to variation are mentioned under “X” and their structure is reproduced below. Several positions are preferentially occupied by specific amino acids, which is also listed below:
SEQ ID NO: 12
XPXXXPSKXXXQXQLXXLXVXXEXXMXGYSRXXFPHWXXQGXGCXTRQXVLXRDADXXSG XCPXTXGXWYSYXDGXXXXXPSXXDXDHXVPLAEAWRSGASSWXTXXRXXFANDLXGXQL IAVXASXNRXKGDQDPSTWXPXRXXAXCXYXKXWXXTKXXXXLXLQSXEKXXLXXMLXXC XY
SEQ ID NO:13
LPPGTPSKSXAQSQLNALXVXXEXSMTGYSRXXFPHWSSQGGGCDTRQVVLKRDADXXSG XCPVTSGKWYSYFDGXXFTNPSDLDIDHIVPLAEAWRSGASSWTTSKRXXFANDLNGPQL IAVXASXNRXKGDQDPSTWQPPRAAARCAYSKWWISTKYKWGLSLQSXEKXXLXXMLXXC AY
1: L, F, I, T, P; preferably L or I, preferably L;
3: P, S; preferably P;
4: G, E, V, preferably G, V, preferably, G;
5: T, I; preferably T;
9 S, A, preferably S;
10. (sequences 12 and 13). A, E, Q, T, preferably E, Q;
11. A, S; preferably A;
13. S, T; preferably S;
16. N, D; preferably N;
17 A, S, G; preferably A, S;
19 (sequences 12 and 13). T, A; preferably T;
21 (sequences 12 and 13). K, Q; preferably K;
22 (sequences 12 and 13). A, P, T, S; preferably P or S;
24 (sequences 12 and 13). D, S, G; preferably D;
25. P, T, A, S; preferably P, S;
27. T, S; preferably T;
32. (sequences 12 and 13). D, N;
33. (sequences 12 and 13). L, H, K;
38. N, S, I, T;
39. S, G, preferably S;
42. S, G, N;
45. D, N;
49. I, L, V, M;
52. Q, K;
57 (sequences 12 and 13), Y, S; preferably Y;
58 (sequences 12 and 13). Y, F, preferably Y at least one Y residue at positions 57/58, preferably positions 57 and 58 are occupied by 2 Y residues;
59. S, T; preferably S;
61 (sequences 12 and 13). N, A, T, S, D; preferably A;
64. V, T; preferably V;
66. S, T; preferably S;
68. R, K, S; preferably R, K;
73. F, Y;
76 (sequences 12 and 13). I, V;
77 (sequences 12 and 13). V, I, T, K;
78. V, F;
79. T, Y;
80. S, D, N; preferably S;
83. E, D, N; preferably E, D;
84. I, L;
86. I, V; preferably I
89. I, V; preferably I; at least 1 I at positions 86/89;
104. S, T; preferably T;
106. E, S, Q, A, T;
107. K, Q; preferably K;
109. (sequences 12 and 13). E, K, Q, R; preferably Q or R, preferably R
110. (sequences 12 and 13). E, S, A, N, D; preferably N or D, preferably N
116. N, T, G, S; preferably N, S;
118. P, S, preferably P;
124 (sequences 12 and 13). S, T;
127 (sequences 12 and 13). T, S, V; preferably S, V;
130 (sequences 12 and 13). S, A; preferably S;
140. Q, K; preferably Q;
142. P, T; preferably P;
144. A, V, S, Y;
145. A, G, S; preferably G;
147. R, H, K, A; preferably R;
149. G, A;
151. S, A; preferably A;
153. W, M; preferably W;
155. I, V. preferably I;
156. N, S; preferably N;
159. H, Y, S; preferably Y, H;
160. R, V, K; preferably R, K, preferably R;
161. W, Y; preferably W;
162. D, G, N, preferably G, D;
164. S, H, N;
168 (sequences 12 and 13). S, A; preferably S;
171 (sequences 12 and 13). S, T, N; preferably S;
172 (sequences 12 and 13). S, A, G, preferably S, A;
174 (sequences 12 and 13). Q, E; preferably Q;
175 (sequences 12 and 13). T, S, G;
178 (sequences 12 and 13). N, D; preferably N;
179 (sequences 12 and 13). T, G, S; preferably T, S, preferably T;
181. S, A.

Thus, the first aim of this invention is a liquid composition for preventing or removing a biofilm, comprising one or more surfactant(s), one or more sequestering agents and a phosphodiesterase having a deoxyribonuclease (DNAse) activity, said DNAse being one or more HNH type DNAse(s) (having a GYS motif) and/or having at least 95% identity with one of the sequences 1 to 13, or even with the DNAses of the sequences 1 to 18.

Preferably said liquid composition comprises at least 7% by weight of water, preferably at least 10% of water, or at least 20% of water. preferably, in this composition, the DNAse(s) has at least 95% identity with one of the sequences 1 to 13, or even with the DNAses of the sequences 1 to 18. Preferably, in this composition, the DNAse(s) has at least 95% identity with one of the sequences 1 to 13, or even with the DNAses of the sequences 1 to 18.

In the context of this invention, identity is preferably measured by an alignment of a sequence to be tested with one of the sequences 1 to 13 (or 1 to 18) over their entire length (182 amino acids). The default parameters of BLASTp are advantageously used, such as a Blosum62 type matrix, a “word” of size 6, a “gap” penalty of 11 and a “gap” extension penalty of 1. Therefore, the percent identity is calculated without ambiguity. Advantageously, in the calculation above, a “gap” will be counted as a single difference, regardless of its length.

Similarly, when a DNAse is to be compared with sequences 12 and 13, a global alignment is performed as described above, and an amino acid of the sequence to be compared that would be identical to the variants of sequences 12 or 13 listed at the different positions marked with the symbol “X” is counted as identical. For example, a sequence to be compared would be aligned with sequence 12 or 13. If the amino acid of this sequence to be compared at the position corresponding to position 10 of sequence 12 or 13 is an alanine, it will be considered identical.

A sequence that would have equivalent enzyme activity, but which would be longer (e.g. addition of sequences for purification or sequences for increasing stability, or even a signal sequence), or shorter, is also covered by this invention, provided that the enzyme in question shares at least 95% of identity with one of the sequences 1 to 13 (or 1 to 18).

Alternatively, identity can be inferred after a global alignment as above and by applying a tolerance of less than 10, less than 9, less than 8, less than 7, less than 6, less than 5, less than 4, less than 3 variations or “gaps” between a target sequence and any of sequences 1 to 13 (or 1 to 18).

### Additional Enzymes

Advantageously, the composition further comprises one or more enzyme activity(ies) chosen from one (or more) protease, a laccase, an amylase, a lipase, a cellulase, a mannanase, a β-1,6-N-acetylhexosaminidase (Dispersin B) activity and a mixture thereof, preferably a protease (or even several proteases) and/or β-1,6-N-acetylhexosaminidase (Dispersin B), preferably a protease (or even several proteases) and/or a β-1,6-N-acetylhexosaminidase (Dispersin B) and another enzyme, or several other enzymes, selected from a laccase, an amylase, a lipase, a cellulase and a mannanase.

For example, a preferred composition comprises the DNAse described above and one (or more) proteases, one (or more) amylase and one (or more) cellulases.

A preferred composition may also comprise the DNAse described above and another nuclease, as well as, advantageously, a protease (or even a cellulase and/or an amylase and/or a second protease).

One or more enzymes catalysing redox reactions may advantageously be added.

Indeed, even if the addition of several enzyme activities is difficult, in particular in terms of stability, for example due to the sequestering agents (see below) or the endogenous activity of the protease, the inventors have noticed that a presence of several different enzyme activities offers a broader spectrum of activity, which is advantageous since, in general, the composition of the biofilms to be treated is unknown, or the biofilms to be treated even comprise several different structural elements: the already remarkable effect of the DNAse of the invention is further strengthened by the additional enzyme activities.

### Other Components

The surfactant(s) are not particularly limited. Anionic, neutral and/or zwitterionic surfactants may be present. The inventors have noted that alkyl polyglucoside surfactants work well, as do alkyl amine zwitterionic surfactants (e.g., 12 and/or 14 and/or 16 and/or 18 carbons).

When the composition is to be applied to vertical surfaces, for example a siphon, a foaming surfactant is advantageously included. In addition, a foaming enhancing agent, such as betaine derivatives, and/or zwitterionic surfactants having a quaternary amine are advantageously added.

Typically, these surfactants are present in a (final) content of at least 1%, weight:volume. Advantageously, their content does not exceed 15% (by weight:volume; sum of the weights of the surfactants:volume).

Preferably, in the composition according to the invention, the sequestering agent(s) is (are) chosen from the group consisting of citrate, carboxymethylinulin, a phosphate, a phosphonate, and amino acid derivatives (Glutamate and tetrasodium diacetate, GLDA; trisodium methylglycine diacetate, MGDA), sodium iminodisuccinate; IDS, gluconate (e.g. sodium gluconate) and mixtures thereof. Preferably, the sequestering agent(s) is (are) chosen from the group consisting of citrate, carboxymethylinulin, a phosphate, a phosphonate, gluconate and mixtures thereof. These are preferably mild sequestering agents. The inventors have noted that these sequestrants do not interfere with the activity of the DNAse of the invention, or with the activity of the other enzymes listed above (when they are present).

Advantageously, the composition according to the invention further comprises glycerol and/or monopropylene glycol. The inventors have noted that this type of molecule increases the stability of the composition according to the invention. An advantageous content is approximately 5 to 30% by weight of the glycerol and/or monopropylene glycol: volume of the solution, preferably 7 to 15% (weight:volume), such as 8 to 12% (weight:volume), or approximately 10%±0.5% (weight of glycerol and/or monopropylene glycol:volume). Sorbitol may also be included for the same purpose.

Conversely, or in addition, the liquid composition according to the invention comprises (in addition to glycerol and/or monopropylene glycol) advantageously water, for example at least 5% by weight, preferably at least 10% by weight.

Furthermore, advantageously, the liquid composition according to the invention is present in a concentrated formulation, which is diluted (e.g. 10 times, 100 times, or more) in water just before use.

Some compositions are however advantageously directly formulated as “ready to use”; for example compositions comprising foaming surfactants (e.g. as described above for the treatment of siphons); a more detailed description of this will be provided below. Foaming surfactants include those with an “HLB” (Hydrophilic-lipophilic-Balance) value of between 3 and 8. Alternatively, several anionic or zwitterionic surfactants may be used, preferably in synergy with a betaine derivative, such as 1-propanaminium, 3-amino-N-(carboxymethyl)-N,N-dimethyl-, N-acyl (acyl being a hydrocarbon chain with an even number of carbons, for example 18),

Similarly, advantageously, the composition according to the invention further comprises a preservative, preferably an isothiazolinone such as Benzisothiazolinone, or (2-)phenoxyethanol.

Advantageously, the composition according to the invention comprises at least 40% (by volume:volume) of water. This composition should not be diluted too much before use. On the other hand, too high a water content risks harming the stability of the composition over time.

Preferably, the composition according to this invention comprises at least 60% water (volume:volume) and, preferably, this composition further comprises β-1,6-N-acetylhexosaminidase (Dispersin B).

This is a composition that can advantageously be used in a second step for the treatment of surfaces, in particular internal surfaces of piping that have been previously treated with compositions comprising a protease and one or more polysaccharidases, or even a laccase. This reduces the interference between the different enzyme activities especially when preserving the composition, but does involve an additional step in the treatment.

A related aspect of this invention relates to a composition comprising a polyol, β-1,6-N-acetylhexosaminidase (Dispersin B) and a phosphodiesterase having a deoxyribonuclease activity (DNAse), said DNAse being one or more HNH-type DNAse(s) and/or having at least 95% identity with one of the sequences 1 to 13 (or 1 to 18). This composition is advantageous in step-based biofilm treatment methods (see the preceding paragraph and below, the two-step method)

Another related aspect of this invention relates to a composition (with at least one HNH-type DNAse and/or having at least 95% identity over the entire sequence with any of Sequences 1 to 13, or 1 to 18) that is “ready to use”, comprising at least 90%, or even at least 95% of water (weight of water: weight of the composition) and from 1 to 10% (for example from 2 to 5%) of the other components (sum of the weights of the components other than water: total weight of the composition): the DNA according to the invention, the possible other enzymes (preferably one or more proteases; amylase, optionally a lipase, or even the other enzymes described above), a sequestering agent and one or more surfactants, or even one or more carrier compounds if present.

Preferably such a “ready-to-use” composition comprises a foaming surfactant and/or a betaine derivative as described above.

A further related aspect of this invention relates to the use of the composition according to the invention (with at least one HNH-type DNAse and/or having at least 95% identity over the entire sequence with any of Sequences 1 to 13, or 1 to 18) for the elimination of a biofilm comprising a lactic acid bacterium selected from Lacobacillus sp, Pediococcus sp, Lactococcus sp. Streptococcus sp, Teragenococcus sp, Leuconostoc sp, Oenococcus sp, Bifidobacterium sp,
and/or
Listeria sp (or L. monocytogenes), Stenotrophomonas maltophilia, Bacillus sp. (B. cereus, B. subtilis)
and/or Pseudomonas sp. (eg Pseudomonas fluorescens or Pseudomonas aeruginosa), Staphylococcus aureus, Escherichia coli, Klebsiella pneumoniae, Enterobacter cloacae, Citrobacter freundii, Staphylococcus epidermidis, Clostridium sp.

Indeed, in the case of biofilms comprising the microorganisms listed above, the inventors have noted the superiority of the DNAse according to the invention compared to other nucleases, even nucleases considered to be excellent. This superiority is measured either alone or in synergy with other enzyme activities.

Another related aspect of this invention relates to a method for removing a biofilm on a surface comprising the application to this surface of the liquid composition according to the invention, comprising the DNAse (or several DNAses) according to the invention (with at least one DNAse of the HNH type and/or having at least 95% identity over the entire sequence with any of Sequences 1 to 13, or 1 to 18).

Preferably, this method can involve two steps, where
a solution comprising one or more detergents and one or more enzyme activities is added,
followed by the addition of a composition comprising a phosphodiesterase having a deoxyribonuclease (DNAse) activity, said DNAse being one or more HNH type DNAse(s) and/or having at least 95% identity with one of the sequences 1 to 13, or 1 to 18,
followed, optionally, by a rinsing and/or disinfection step.

This method (with a single step or two steps) is particularly advantageous when the surface is one or more internal surface(s) of a substantially closed circuit, preferably a piping system or a fermenter. This is a surface that is difficult to access, but whose biofilms, when they have developed there, are significantly destructured thanks to the DNAse according to the invention.

### EXAMPLES

Two different biofilms were tested, in order to encounter a diversity of microorganisms: a biofilm consisting of Lactococcus lactis and a biofilm consisting of Pseudomonas fluorescens. These biofilms were generated by applying bacterial suspensions on agar at 37° C. in multiwell plates (24 wells), for 48 h (Pseudomonas) or 24 h (Lactococcus). Microorganisms are quantified by spectrometry, in this case at 590 nm (570 nm is also OK) following staining with “Crystal Violet”.

Different conditions are provided for per plate, which is shown schematically in Table 1 below:

TABLE 1
Overview of the different conditions for the tests.
Each condition is therefore in triplicate.

| Positive | Positive | Positive | Negative | Negative | Negative |
|---|---|---|---|---|---|
| control | control | control | control | control | control |
| Cip | Cip + | Cip + | A1 + 10 | A1 + 10 + | A1 + 10 + |
| | Denarase | DNAse | | Denarase | DNAse |
| Cip | Cip + | Cip + | A1 + 10 | A1 + 10 + | A1 + 10 + |
| | Denarase | DNAse | | Denarase | DNAse |
| Cip | Cip + | Cip + | A1 + 10 | A1 + 10 + | A1 + 10 + |
| | Denarase | DNAse | | Denarase | DNAse |

Bacteria are seeded in all wells, except for the “negative controls”.

All solutions are sterile and they are added very carefully so as not to cause mechanical disturbances to the biofilms.

The wells of the “Positive control” and “Negative control” conditions were incubated with 1 ml of physiological saline.

The other wells were incubated for 30 minutes at 45° C. with 1 ml of the following solutions (the percentages below are in weight:volume):
Biorem-CIP (Realco): 1%;
Denarase and DNAse: 0.01% of the enzyme solutions, in order to ensure a standardised activity;
Biorem A1+10: the solutions sold by Realco, diluted to 0.25% (A1) and 0.05% (Biorem 10). These solutions include detergents/surfactants (>1% C6 alkyl glucoside), sequestrants (a phosphonate; >15%), and several enzyme activities, including a protease, an amylase and a laccase.

Biorem CIP also contains detergents/surfactants (>1% C6 alkyl glucoside), sequestrants (>1% sodium citrate), and a dispersing agent and several enzyme activities, including a protease, an amylase and a laccase. The composition was applied at 1%.

The Biorem compounds are also described, for example in the patent application WO2012048758A1 as well as in the corresponding patents.

Then the wells are carefully emptied, taking care not to remove the biofilms or fragments thereof. After rinsing with physiological water, the plate containing the biofilms is dried in an oven for one hour at 45° C. Once the biofilm is dried, Crystal violet (0.1%) is added for a 15-minute incubation at room temperature, followed by three rinses with distilled water. Finally, the wells are filled with 44% acetic acid for incubation at room temperature for one hour. The absorbance measurement at 590 nm can now be performed. If the Crystal Violet concentrations are too high and the spectrophotometer saturates, then a ten-fold dilution is performed.

The results for Lactococcus lactis are shown in Table 2 below:

TABLE 2
Effectiveness of different nucleases for the destruction
of biofilms consisting of Lactococcus lactis and
synergy with an enzyme composition.

| | Cip + | Cip + | | A1 + 10 + | A1 + 10 + |
|---|---|---|---|---|---|
| CIP | Denarase | DNAse | A1 + 10 | Denarase | DNASE |
| 60.6% | 66.5% | 71.3% | −4.8% | 4.5% | 47.0% |
| 59.4% | 61.1% | 63.7% | −2.5% | 0.0% | 55.2% |
| 49.9% | 53.8% | 65.1% | 10.4% | 5.4% | 61.1% |

The inventors further tested, in another series of experiments, the effect of DNAse alone or Denarase alone, and observed a very good effectiveness of DNAse alone on Lactococcus lactis, which is further increased by approximately 20% by Biorem, while Denarase alone has only marginal activity.

The results for Pseudomonas fluorescens are shown in Table 3 below:

TABLE 3
Effectiveness of the different nucleases for the destruction
of biofilms consisting of Pseudomonas fluorescens
and synergy with an enzyme composition.

| | Cip + | Cip + | | A1 + 10 + | A1 + 10 + |
|---|---|---|---|---|---|
| CIP | Denarase | DNAse | A1 + 10 | Denarase | DNASE |
| 84.4% | 71.8% | 75.5% | 19.0% | 44.1% | 70.0% |
| 81.3% | 73.6% | 69.7% | 13.0% | 42.7% | 66.3% |
| 71.0% | 70.5% | 73.5% | 17.0% | 46.8% | 63.4% |

As for L. lactis, the inventors tested in a second series of experiments the effect of DNAse alone and observed a strong activity of DNAse alone, which is somewhat increased by Biorem.

Hence the inventors conclude that the DNAse of the invention is clearly superior, especially in synergy with the less intense conditions for Biorem A1+10, compared with Biorem CIP. Advantageously, for Lactococcus lactis, where the effectiveness of Biorem CIP is a little less marked, the synergy with DNAse is better demonstrated.

Another series of experiments was performed in synergy with other enzyme compositions (Enzimed Prevent, which comprises a protease, a cellulase, an amylase and a mannanase; the first 2 columns of the tables below, without or with the DNAse of this invention), and a comparison was made with other commercial compositions: alkaline detergent compositions with protease activity (3rd column; DAP), i.e. an enzyme degreasing cocktail, two separate commercial formulations (4th and 5th columns; DE1 and DE2), a multi-enzyme disinfectant detergent containing a quaternary ammonium (6th column; DMQ) or a non-enzyme disinfection composition for endoscopes (7th column; DME). The compositions were tested at a concentration of 0.5%.

The biofilm of the species to be tested is formed in a 96-well plate. The enzyme detergents are then diluted to their usual concentration in standard hardness water (demineralised water) and incubated on the biofilm for 1 hour at 37° C. The amount of biomass remaining after treatment and washing of the biofilm is then evaluated by crystal violet staining (2% sigma solution).

This test is carried out on reference strains in 96-well plates, namely:
S. aureus ATCC33591: 24 h biofilm (TGN)
E. coli ATCC25922: 48 h biofilm (LB)
P. aeruginosa ATCC27853 and PAO1: 48 h biofilm (TGN)

### Solutions:

TGN (TSB+1% glucose+2% NaCl)
LB (for E. coli)
“Distilled” water: sterilised by filtration (0.22 micron), finally containing 1.25 mM MgCl2, 2.5 mM CaCl2, 3.33 mM NaHCO3.
2% Crystal Violet (Crystal Violet solution, Sigma-Aldrich, ref: HT90132-1L)
Acetic acid 66% (Glacial acetic acid 100%, ref: K48283163635, Millipore)
Tryptic soy agar (TSA; BD benelux-ref 254086) plates

The solutions were preheated to 37° C., in order to prevent the biofilms from being subjected to thermal shock.

Method:
D0: Start an overnight culture. 5 ml TGN+20 μl bacteria. Incubate for 18 hours at 37° C. with slow stirring, 130 rpm
D1: Preparation
Add 200 ml of the inoculum (OD 0.05) to each well of a 96-well plate following the plate plan (VWR).
Perform a non-contamination test on the liquid preculture
Streak the preculture on a TSA plate. Incubate overnight @37° C. The next day, ensure there is no contamination.
   Biofilm growth:
For S. aureus 24 h @37°° C.
Incubate the plate at 37° C. for 24 hours in a closed box to prevent evaporation. Note the time to have a biofilm of exactly 24 hours.
For E. coli: 48 h with change of environment after 24 h @37° C.:
   Incubate the plate at 37° C. for 24 hours in a closed box to prevent evaporation (LB not TGN).
   Carefully remove the medium by pipetting
   Add 200 μl of preheated LB
   Incubate for 24 hours more @37° C. in a closed box to prevent evaporation.
For P. aeruginosa: 48 h @37° C.
   Incubate the plate at 37° C. for 48 hours in a closed box to prevent evaporation. Note the time of exactly 48 hours to have a biofilm.
D2: After biofilm growth
Remove the culture medium from the biofilm plates by suction, avoiding touching the biofilm
Rinse the plates once with pre-warmed sterile PBS (remove the PBS after 30 sec)
   Enzyme treatment:
Prepare the enzyme solutions at the desired concentrations according to the preparation protocol appendix
Add 230 μl of the enzyme solutions to empty 96-well plates according to the plate scheme
Heat these plates in a water bath at 37° C. or in the incubator for 15 min
Transfer 200 μl of heated enzymes into the wells of the 96-well plates containing the biofilms by pipetting horizontally
Incubate the plates at 37° C. for 1 h
Remove the enzymes from the treated plates by suction
Rinse the plates twice with pre-warmed sterile PBS, between each step, remove the PBS by suction
   Staining of biomass with crystal violet
Dry the plates in the oven at 60° C. overnight to fix the biofilm
Add 200 ml of 2% crystal violet solution to the plates (including the negative control)
Incubate the plates at room temperature for 15 min
Empty the plates and rinse them at least five times with distilled water
Drain the plates for a few minutes to remove the rinsing water from the wells
Add 200 μl of 66% acetic acid to the plates (including the negative control)
Incubate the plates at room temperature for at least 1 hour
Measure the absorbance values with spectramax (570 nm) and make dilutions in acetic acid if some values on the plate are >2

| | | | | | | |
|---|---|---|---|---|---|---|
| Prevent | Prevent | DAP | DE1 | DE2 | DMQ | DME |
| | DNase | | | | | |
| Prevent | Prevent | DAP | DE1 | DE2 | DMQ | DME |
| | DNase | | | | | |
| Prevent | Prevent | DAP | DE1 | DE2 | DMQ | DME |
| | DNase | | | | | |
| Prevent | Prevent | DAP | DE1 | DE2 | DMQ | DME |
| | DNase | | | | | |
| Average | Average | Average | Average | Average | Average | Average |

### Experiment 1

S.a. ATCC33591

| | | | | | | |
|---|---|---|---|---|---|---|
| −39.74% | 53.51% | −35.53% | −6.59% | −40.29% | −82.20% | −127.91% |
| −41.64% | 58.13% | −22.85% | 8.94% | −50.72% | −54.66% | −79.70% |
| −46.01% | 47.95% | −37.97% | −12.84% | 10.76% | −58.17% | −69.36% |
| −53.74% | 71.68% | −4.82% | −4.10% | −30.27% | −47.79% | −60.38% |
| −45.28% | 57.82% | −25.29% | −3.65% | −27.63% | −60.71% | −84.34% |

P.a ATCC27853

| | | | | | | |
|---|---|---|---|---|---|---|
| 84.47% | 72.46% | −65.13% | 20.89% | 65.93% | 5.25% | −38.69% |
| 21.94% | 68.72% | 23.35% | −163.74% | −61.13% | −50.98% | −15.25% |
| 70.40% | 42.01% | −38.45% | 50.40% | 43.30% | −10.37% | 2.97% |
| 66.33% | 78.09% | −43.58% | 27.90% | 10.55% | −24.63% | −10.04% |
| 60.79% | 65.32% | −30.95% | −16.13% | 14.67% | −20.18% | −15.25% |

E. coli

| | | | | | | |
|---|---|---|---|---|---|---|
| 61.81% | 71.55% | 62.88% | 22.74% | −8.94% | −164.16% | −78.99% |
| 50.23% | 68.19% | 60.15% | 50.00% | 57.15% | −78.08% | −17.36% |
| 54.03% | 58.06% | 65.55% | 46.45% | −2.29% | −59.41% | −45.90% |
| 47.10% | 51.80% | 53.96% | 50.42% | 14.28% | −89.21% | −72.50% |
| 53.29% | 62.40% | 60.64% | 42.40% | 15.05% | −97.71% | −53.69% |

### Experiment 2

S.a. ATCC33591

| | | | | | | |
|---|---|---|---|---|---|---|
| 59.54% | 72.96% | 53.71% | 15.33% | 8.38% | −53.92% | −88.09% |
| 56.34% | 62.52% | 21.92% | 12.93% | 19.15% | −14.20% | −59.52% |
| 52.78% | 65.93% | 37.01% | 24.38% | 33.03% | −20.80% | −71.15% |
| 53.24% | 53.51% | 33.51% | 16.55% | 20.44% | −23.67% | −48.41% |
| 55.48% | 63.73% | 36.54% | 17.30% | 20.25% | −28.15% | −66.79% |

P.a. ATCC27853

| | | | | | | |
|---|---|---|---|---|---|---|
| 2.57% | 68.34% | 5.24% | 27.88% | −14.59% | −75.24% | −41.39% |
| 38.24% | 74.92% | 20.99% | 24.22% | 10.76% | −0.32% | −23.42% |
| 35.44% | 68.48% | −4.60% | 23.21% | −59.29% | −29.17% | −52.90% |
| 53.85% | 40.58% | 8.23% | −186.87% | −179.55% | 0.51% | −3.32% |
| 32.52% | 63.08% | 7.47% | −27.89% | −60.67% | −26.06% | −30.25% |

E. coli

| | | | | | | |
|---|---|---|---|---|---|---|
| 73.70% | 74.52% | 79.99% | 42.88% | 47.41% | −145.36% | −146.16% |
| 71.32% | 81.67% | 72.38% | 58.29% | 46.13% | −17.77% | −39.49% |
| 45.21% | 73.00% | 68.24% | 55.60% | 58.20% | 25.12% | −39.89% |
| 55.55% | 73.78% | 77.73% | 72.05% | 52.11% | 24.09% | −4.80% |
| 61.45% | 75.74% | 74.59% | 57.21% | 50.96% | −28.48% | −57.59% |

Thus, the Enzimed Prevent product alone is consistently effective against E. coli and P. aeurginosa, but its effectiveness against S. aureus is variable. However, this Enzimed composition enriched with the DNAse of this invention shows systematically and consistently increased activity, even against S. aureus. Other cleaning or even disinfecting compositions are less effective and sometimes not at all effective on the biofilms tested.

1. A liquid composition for preventing or removing a biofilm, comprising one or more surfactant(s), one or more sequestering agent(s) and a phosphodiesterase having deoxyribonuclease (DNAse) activity, said DNAse being one or more HNH-type DNAse(s) and/or having at least 95% identity with one of the sequences SEQ ID NO: 1 to SEQ ID NO: 13.

2. Composition according to claim 1 wherein the DNAse has at least 95% identity with one of the sequences SEQ ID NO: 1 to SEQ ID NO: 13.

3. Composition according to claim 1 further comprising one or more enzyme activity(ies) selected from a protease, a laccase, an amylase, a lipase, a cellulase, a mannanase, a β-1,6-N-acetylhexosaminidase (Dispersin B) activity and a mixture thereof, preferably a protease and/or β-1,6-N-acetylhexosaminidase (Dispersin B).

4. Composition according to claim 1 wherein the sequestering agent(s) is (are) selected from the group consisting of citrate, carboxymethylinulin, a phosphate, a phosphonate, tetrasodium glutamate diacetate (GLDA), trisodium methylglycine diacetate (MGDA), sodium iminodisuccinate (SID), a gluconate and mixtures thereof.

5. Composition according to claim 1 further comprising glycerol and/or monopropylene glycol, preferably between 5 and 30% (weight:volume).

6. Composition according to claim 1 further comprising a preservative, preferably an isothiazolinone such as Benzisothiazolinone, or a phenoxyethanol.

7. Composition according to claim 1 further comprising at least 7% water (weight:volume).

8. Composition according to claim 1 comprising at least 60% water (weight:volume), preferably said composition further comprising β-1,6-N-acetylhexosaminidase (Dispersin B).

9. Composition according to claim 1 comprising at least 90% water (weight: volume) and a foaming surfactant.

10. A liquid composition comprising β-1,6-N-acetylhexosaminidase (Dispersin B) and a phosphodiesterase having deoxyribonuclease (DNAse) activity, said DNAse being one or more HNH-type DNAse(s) and/or having at least 95% identity with one of the sequences SEQ ID NO: 1 to SEQ ID NO: 13.

11. Use of the composition according to claim 1 for the elimination of a biofilm comprising a lactic acid bacterium selected from Lacobacillus sp, Pediococcus sp, Lactococcus sp. Streptococcus sp, Teragenococcus sp, Leuconostoc sp, Oenococcus sp, Bifidobacterium sp,
and/or Listeria monocytogenes, Stenotrophomonas maltophilia, Bacillus cereus, Bacillus subtilis,
and/or Pseudomonas fluorescens, Pseudomonas aeruginosa, Staphylococcus aureus, Escherichia coli, Klebsiella pneumoniae, Enterobacter cloacae, Citrobacter freundii, Staphylococcus epidermidis or Clostridium sp.

12. Method for removing a biofilm from a surface comprising the application to said surface the liquid composition according to claim 1.

13. Method for removing a biofilm from a surface, wherein
a solution comprising one or more detergents and one or more enzyme activities is added,
followed by adding a composition comprising a phosphodiesterase having a deoxyribonuclease (DNAse) activity, said DNAse being one or more HNH-type DNAse(s) and/or having at least 95% identity with one of the sequences SEQ ID NO: 1 to SEQ ID NO: 13,
followed, optionally, by a rinsing and/or disinfection step.

14. Method according to claim 12, wherein the surface is one or more internal surface(s) of a substantially closed circuit, preferably a piping system or a fermenter.

15. Use of the composition according to claim 10 for the elimination of a biofilm comprising a lactic acid bacterium selected from Lacobacillus sp, Pediococcus sp, Lactococcus sp. Streptococcus sp, Teragenococcus sp, Leuconostoc sp, Oenococcus sp, Bifidobacterium sp,
and/or Listeria monocytogenes, Stenotrophomonas maltophilia, Bacillus cereus, Bacillus subtilis,
and/or Pseudomonas fluorescens, Pseudomonas aeruginosa, Staphylococcus aureus, Escherichia coli, Klebsiella pneumoniae, Enterobacter cloacae, Citrobacter freundii, Staphylococcus epidermidis or Clostridium sp.

16. Method according to claim 13, wherein the surface is one or more internal surface(s) of a substantially closed circuit, preferably a piping system or a fermenter.


SEQUENCE LISTING (18 sequences)

SEQ ID NO: 1 - protein, 182 aa, Bacillus sp.
LPPGTPSKSEAQSQLNALTVKPEDPMTGYSRDHFPHWISQGNGCNTRQIVLQRDADYYSGACPVTTGKWYSYFDGVIVYSPSEIDIDHIVPLAEAWRSGASSWTTEKRRSFANDLNGPQLIAVTASVNRSKGDQDPSTWQPPRAGARCAYAKWWINTKHRWGLHLQSSEKSSLQSMLNGCAY

SEQ ID NO: 2 - protein, 182 aa, Bacillus sp.
LPPGTPSKSEAQSQLNSLTVKTEDPMTGYSRDLFPHWSGQGSGCDTRQIVLQRDADYFTGTCPTTSGKWYSYFDGVIVYSPSEIDVDHIVPLAEAWRSGASSWTTEQRRAFANDLTGPQLIAVTASVNRSKGDQDPSTWQPPRAGARCAYAKWWINTKHRWNLHLQSSEKSSLQTMLNGCAY

SEQ ID NO: 3 - protein, 182 aa, Bacillus sp.
LPPGTPSKSEAQSQLNALTVKAEDPMTGYSRNLFPHWNSQGNGCNTRQLVLQRDADYYSGNCPVTSGRWYSYFDGVVVTSPSEIDIDHIVPLAEAWRSGASSWTTEKRKEFANDLNGPQLIAVTASVNRSKGDQDPSTWQPPRAAARCGYAKWWINTKYRWDLSLQSSEKSSLQTMLNTCSY

SEQ ID NO: 4 - protein, 182 aa, Bacillus sp.
LPPGTPSKSQAQSQLNALTVKAEDPMTGYSRNLFPHWSSQGNGCNTRQLVLQRDADYYSGNCPVTSGRWYSYFDGVVVTSPSEIDIDHIVPLAEAWRSGASSWTTEKRREFANDLNGPQLIAVTASVNRSKGDQDPSTWQPPRVAARCGYAKWWINTKYRWDLSLQSSEKSSLQTMLNTCSY

SEQ ID NO: 5 - protein, 182 aa, Bacillus sp.
FPPEIPSKSTAQSQLNSLTVKSEDAMTGYSRDKFPHWISQGDGCDTRQMVLKRDADYYSGSCPVTSGKWYSYYDGITVYSPSEIDIDHIVPLAEAWRSGASSWTTEKRRNFANDLNGPQLIAVTASVNRSKGDQDPSTWQPPRSGARCAYAKMWVNTKYRWGLHLQSAEKSGLESMLNTCSY

SEQ ID NO: 6 - protein, 182 aa, Bacillus sp.
FPPGTPSKSTAQSQLNSLTVKSEGSMTGYSRDKFPHWIGQGSGCDTRQLVLQRDADYYSGSCPVTSGKWYSYYDGVTFYDPSDLDIDHVVPLAEAWRSGASSWSTQKRKDFANDLSGPQLIAVSASSNRSKGDQDPSTWQPTRSGAACGYSKWWISTKHKWGLSLQSSEKNALQGMLNSCVY

SEQ ID NO: 7 - protein, 182 aa, Bacillus sp.
IPPGTPSKSAAQSQLDSLAVQSEGSMSGYSRDKFPHWIGQGNGCDTRQLVLQRDADYYSGDCPVTSGKWYSYFDGVQVYDPSYLDIDHMVPLAEAWRSGASSWSTQKREDFANDLDGPHLIAVTASSNRSKGDQDPSTWKPTRYSAHCGYAKWWINTKYVYDLNLQSSEKSALQSMLNTCSY

SEQ ID NO: 8 - protein, 182 aa, Paenibacillus mucilaginosus
LPPGTPSKSTAQSQLNSLTVKSESTMTGYSRDKFPHWTSQGGGCDTRQVVLKRDADYYSGSCPVTSGKWYSYYDGITVYSPSEIDIDHIVPLAEAWRSGASSWTTEKRQNFANDLGGPQLIAVTASSNRAKGDQDPSTWKPTRSGAHCAYAKWWINTKYRWGLHLQSSEKTALQSMLNTCSY

SEQ ID NO: 9 - protein, 182 aa, Bacillus sp.
TPPGTPSKSTAQTQLNALTVKTEGSMTGYSRDLFPHWISQGSGCDTRQVVLKRDADYYSGSCPVTSGKWYSYYDGVTFYDPSDLDIDHIVPLAEAWRSGASSWTTSKRQDFANDLSGPQLIAVSASTNRSKGDQDPSTWQPPRAGAACGYSKWWISTKYKWGLSLQSSEKTALQGMLNSCSY

SEQ ID NO: 10 - protein, 182 aa, Bacillus sp.
TPPVTPSKATSQSQLNGLTVKTEGAMTGYSRDKFPHWSSQGGGCDTRQVVLKRDADSYSGNCPVTSGSWYSYYDGVKFTNPSDLDIDHIVPLAEAWRSGASSWTTAQREAFANDLSGSQLIAVSASSNRSKGDQDPSTWQPPRAGAKCGYAKWWISTKSKWNLSLQSSEKTALQGMLNSCVY

SEQ ID NO: 11 - protein, 182 aa, Bacillus sp.
LPSGIPSKSTAQSQLNSLTVKSEGSMTGYSRDKFPHWISQGGGCDTRQVVLKRDADYYSGNCPVTSGKWYSYYDGISVYSPSEIDIDHVVPLAEAWRSGASSWTTTKRQNFANDLNGPQLIAVTASVNRSKGDQDPSTWQPPRYGARCAYAKMWINTKYRWDLNLQSSEKSSLQSMLDTCSY

SEQ ID NO: 12 - protein, 182 aa, synthetic construct
  VARIANT 1: note = L, F, I, T, P
  VARIANT 3: note = P, S
  VARIANT 4: note = G, E, V
  VARIANT 5: note = T, I
  VARIANT 9: note = S, A
  VARIANT 10: note = A, E, Q, T
  VARIANT 11: note = A, S
  VARIANT 13: note = S, T
  VARIANT 16: note = N, D
  VARIANT 17: note = A, S, G
  VARIANT 19: note = T, A
  VARIANT 21: note = K, Q
  VARIANT 22: note = A, P, T, S
  VARIANT 24: note = D, S, G
  VARIANT 25: note = P, T, A, S
  VARIANT 27: note = T, S
  VARIANT 32: note = D, N
  VARIANT 33: note = L, H, K
  VARIANT 38: note = N, S, I, T
  VARIANT 39: note = S, G
  VARIANT 42: note = S, G, N
  VARIANT 45: note = D, N
  VARIANT 49: note = I, L, V, M
  VARIANT 52: note = Q, K
  VARIANT 57: note = Y, S
  VARIANT 58: note = Y, F
  VARIANT 59: note = S, T
  VARIANT 61: note = N, A, T, S, D
  VARIANT 64: note = V, T
  VARIANT 66: note = S, T
  VARIANT 68: note = R, K, S
  VARIANT 73: note = F, Y
  VARIANT 76: note = I, V
  VARIANT 77: note = V, I, T, K
  VARIANT 78: note = V, F
  VARIANT 79: note = T, Y
  VARIANT 80: note = S, D, N
  VARIANT 83: note = E, D, N
  VARIANT 84: note = I, L
  VARIANT 86: note = I, V
  VARIANT 89: note = I, V
  VARIANT 104: note = S, T
  VARIANT 106: note = E, S, Q, A, T
  VARIANT 107: note = K, Q
  VARIANT 109: note = E, K, Q, R
  VARIANT 110: note = E, S, A, N, D
  VARIANT 116: note = N, T, G, S
  VARIANT 118: note = P, S
  VARIANT 124: note = S, T
  VARIANT 127: note = T, S, V
  VARIANT 130: note = S, A
  VARIANT 140: note = Q, K
  VARIANT 142: note = P, T
  VARIANT 144: note = A, V, S, Y
  VARIANT 145: note = A, G, S
  VARIANT 147: note = R, H, K, A
  VARIANT 149: note = G, A
  VARIANT 151: note = S, A
  VARIANT 153: note = W, M
  VARIANT 155: note = I, V
  VARIANT 156: note = N, S
  VARIANT 159: note = H, Y, S
  VARIANT 160: note = R, V, K
  VARIANT 161: note = W, Y
  VARIANT 162: note = D, G, N
  VARIANT 164: note = S, H, N
  VARIANT 168: note = S, A
  VARIANT 171: note = S, T, N
  VARIANT 172: note = S, A, G
  VARIANT 174: note = Q, E
  VARIANT 175: note = T, S, G
  VARIANT 178: note = N, D
  VARIANT 179: note = T, G, S
  VARIANT 181: note = S, A
XPXXXPSKXXXQXQLXXLXVXXEXXMXGYSRXXFPHWXXQGXGCXTRQXVLXRDADXXSGXCPXTXGXWYSYXDGXXXXXPSXXDXDHXVPLAEAWRSGASSWXTXXRXXFANDLXGXQLIAVXASXNRXKGDQDPSTWXPXRXXAXCXYXKXWXXTKXXXXLXLQSXEKXXLXXMLXXCXY

SEQ ID NO: 13 - protein, 182 aa, synthetic construct
  VARIANT 1: note = I
  VARIANT 10: note = E, A, Q, T
  VARIANT 19: note = T, A; note = T,A
  VARIANT 21: note = K, Q
  VARIANT 22: note = A, P, T, S
  VARIANT 24: note = D, S, G
  VARIANT 57: note = Y, S
  VARIANT 58: note = Y, F
  VARIANT 61: note = N, A, T, S, D
  VARIANT 76: note = I, V
  VARIANT 77: note = V, I, T, K
  VARIANT 124: note = S, T
  VARIANT 127: note = T, S, V
  VARIANT 130: note = S, A
  VARIANT 168: note = S, A
  VARIANT 171: note = S, T, N
  VARIANT 172: note = S, A, G
  VARIANT 174: note = Q, E
  VARIANT 175: note = T, S, G
  VARIANT 178: note = T, G, S
  VARIANT 179: note = T, G, S
  VARIANT 10: note = E, Q
  VARIANT 32: note = D, N
  VARIANT 33: note = L, H, K
  VARIANT 109: note = Q, R
  VARIANT 110: note = N, D
LPPGTPSKSXAQSQLNALXVXXEXSMTGYSRXXFPHWSSQGGGCDTRQVVLKRDADXXSGXCPVTSGKWYSYFDGXXFTNPSDLDIDHIVPLAEAWRSGASSWTTSKRXXFANDLNGPQLIAVXASXNRXKGDQDPSTWQPPRAAARCAYSKWWISTKYKWGLSLQSXEKXXLXXMLXXCAY

SEQ ID NO: 14 - protein, 182 aa, unidentified
LPPGTPSKSAAQSQLNALTVKTEGSMSGYSRDLFPHWISQGSGCDTRQVVLKRDADSYSGNCPVTSGSWYSYYDGVTFTNPSDLDIDHIVPLAEAWRSGASSWTTSKRQDFANDLSGPQLIAVSASTNRSKGDQDPSTWQPPRSGAACGYSKWWISTKYKWGLSLQSSEKTALQGMLNSCSY

SEQ ID NO: 15 - protein, 182 aa, unidentified [sequence omitted]

SEQ ID NO: 16 - protein, 182 aa, unidentified; identical to SEQ ID NO: 9

SEQ ID NO: 17 - protein, 182 aa, unidentified; identical to SEQ ID NO: 9

SEQ ID NO: 18 - protein, 182 aa, unidentified; identical to SEQ ID NO: 1